(19) United States
(12) Patent Application Publication
(10) Pub. No.: US 2009/0106056 A1
(43) Pub. Date: Apr. 23, 2009

(54) UNIVERSAL BUSINESS TO MEDIA RESERVATION SYSTEM

(75) Inventors: Jacek Waksmundzki, Warsaw (PL); Pawel Demczuk, Warsaw (PL); Lukasz Michalski, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,513

(22) Filed: Oct. 21, 2008

Related U.S. Application Data
(60) Provisional application No. 60/981,760, filed on Oct. 22, 2007.

(51) Int. Cl. G06Q 10/00

(52) U.S. Cl. 705/5

(57) ABSTRACT

A computer network based universal reservation system (CNBURS) architecture that enables reservations between one or more service providers and one or more customers relating to offers of services by the service providers. In one embodiment, the architecture of the CNBURS includes a scheduling agent system, one or more service offering systems and one or more marketplace systems. The scheduling agent system receives one or more offers of services available for reservation. Each service offering system enables service providers to define the offer(s) of services available for reservation. Each marketplace system receives the offer(s) of services from the scheduling agent system, presents the customers the offer(s) of services, receives reservation requests from the customers, and communicates received reservation requests to the scheduling agent system. The scheduling agent system communicates the offer(s) of services from the service offering system(s) to the marketplace system(s) and processes reservation requests received from the marketplace system(s).

### RELATED APPLICATION INFORMATION

This application claims priority from U.S. Provisional Patent Application Ser. No. 60/981,760 entitled “UNIVERSAL BUSINESS TO MEDIA RESERVATION SYSTEM” filed on Oct. 22, 2007, which is incorporated by reference herein in its entirety.

### FIELD OF THE INVENTION

The present invention relates generally to facilitating the reservation of services offered by service providers, and more particularly to brokering of reservations relating to services in any business domain using multiple analog and digital media.

### BACKGROUND OF THE INVENTION

The Internet and other computer networks have proven to be a useful medium for connecting service providers with persons seeking to obtain services. For example, a patient might utilize the Internet to access their doctor's office Web site to schedule an appointment, a driver might access a car rental agency's Web site via the Internet to reserve a rental car, or a diner might utilize the Internet to access a restaurant's Web site to obtain a dinner reservation. In each of the foregoing examples, the scheduling function is integrated with the system that presents information about the available service. Furthermore, access to the system that presents information about the available services may be limited to particular marketplaces. For example, the doctor's office, car rental agency's, or restaurant's Web site might be accessible via a Web portal, but not via a mobile phone portal or a digital television system. Additionally, the clients seeking services may be presented with a myriad of different scheduling systems and processes in order to reserve a variety of differing services since the clients directly interface with the service offering systems.

### SUMMARY OF THE INVENTION

Accordingly, the present invention provides for a computer network based universal reservation system (CNBURS). The CNBURS provides easy brokering of reservations relating to services between customers and service providers. A “service” may, for example, be considered an arrangement among a service provider and one or more customers by which the customer(s) receives/receive the use of one or more resources from the service provider. Use of the resource(s) may be received by the customer(s) for a scheduled period of time (e.g., for an hour, a day, a week, or the duration of a performance such as a movie, a play, or a sporting event), although it is also possible for the duration of the service to be open-ended. A “resource” may, for example, include a good that is exchanged between the service provider and the customer(s) as well as an activity that is performed for or on behalf of the customer(s). The activity may be performed by one or more individuals, one or more entities, one or more devices, or a combination of individuals, entities and/or devices. In general, a “customer” is any individual or entity that may receive a service from a service provider. The terms “customer” and “client” may be used interchangeably herein. Further, a “reservation” refers to any activity involving scheduling the delivery of a service. A “service provider” may be any individual or entity that possesses resources and is capable of providing the use of those resources to customers. Where the service provider owns a resource, ownership of the resource may be maintained by the service provider during the service.

The present invention provides universality by allowing for the inclusion of every customer who desires to participate and every service provider who desires to participate through every analog and digital media (e.g. newspaper, billboard, Internet, ITV, cell phone, PDA, etc.) and through multiple marketplaces that desire to participate (e.g., universal portals, linked services portals, specialty portals, media portals, etc.).

The CNBURS includes a number of components that communicate with one another via computer networks. The computer networks may, in general, be any public network(s), any private network(s), or any combination of public and private network(s) that provide for the communication of data between devices connected to the network(s). Examples of such computer network(s) include the Internet, private switched telephone networks, cellular telephone networks, cable and satellite television networks, wireless networks, and the like.

The present invention includes various aspects and features. In one aspect, an architecture of a CNBURS that enables reservations between one or more service providers and one or more customers, wherein the reservations relate to offers of services by the service providers, includes a scheduling agent system, one or more service offering systems and one or more marketplace systems. The scheduling agent system is enabled to receive one or more offers of services available for reservation. Each service offering system enables service providers to define one or more offers of services available for reservation with customers. In this regard, an offer or services defined by a service provider may include information indicating whether or not the scheduling agent system is delegated authority to complete reservations with customers relating to the offer of services. Each marketplace system is enabled to receive the one or more offers of services from the scheduling agent system, present the customers the one or more offers of services, receive reservation requests from the customers relating to the one or more offers of services, and communicate received reservation requests to the scheduling agent system. The scheduling agent system communicates the one or more offers of services from the one or more service offering systems to the one or more marketplace systems and processes reservation requests received from the one or more marketplace systems.

In another aspect, an architecture of a CNBURS that enables reservations between one or more service providers and one or more customers, wherein the reservations relate to offers of services by the service providers, includes a scheduling agent system implemented in the form of computer readable program code executable by a computer processor, a plurality of service offering systems implemented in the form of computer readable program code executable by separate computer processors, a plurality of service interface brokers, a plurality of marketplace systems implemented in the form of computer readable program code executable by separate computer processors, and a plurality of marketplace interface brokers. The scheduling agent system is enabled to receive one or more offers of services available for reservation. Each service offering system enables service providers to define one or more offers of services available for reservation with customers. In this regard, offer of services as defined by a service provider may include information indicating whether the scheduling agent system is delegated authority to complete reservations with customers relating to the offer of services. Each service interface broker corresponds with one of the service offering systems and provides an interface between its corresponding service offering system and the scheduling agent system for communication via a computer network between the computer processor executing scheduling agent system program code and the computer processor executing service offering system program code. Each marketplace system is enabled to receive the one or more offers of services from the scheduling agent system, present the customers the one or more offers of services, receive reservation requests from the customers relating to the one or more offers of services, and communicate received reservation requests to the scheduling agent system. Each marketplace interface broker corresponds with one of the marketplace systems and provides an interface between its corresponding marketplace system and the scheduling agent system for communication via a computer network between the computer processor executing scheduling agent system program code and the computer processor executing marketplace system program code. The scheduling agent system communicates the one or more offers of services from the service offering systems to the marketplace systems using the service and marketplace interface brokers and processes reservation requests received from the plurality of marketplace systems.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing one embodiment of a computer network based universal reservation system presenting involved actors and components; and

FIG. 2 is a block diagram showing the architecture of one example of a computing system that may be utilized in implementing various components of the computer network based universal reservation system.

### DETAILED DESCRIPTION

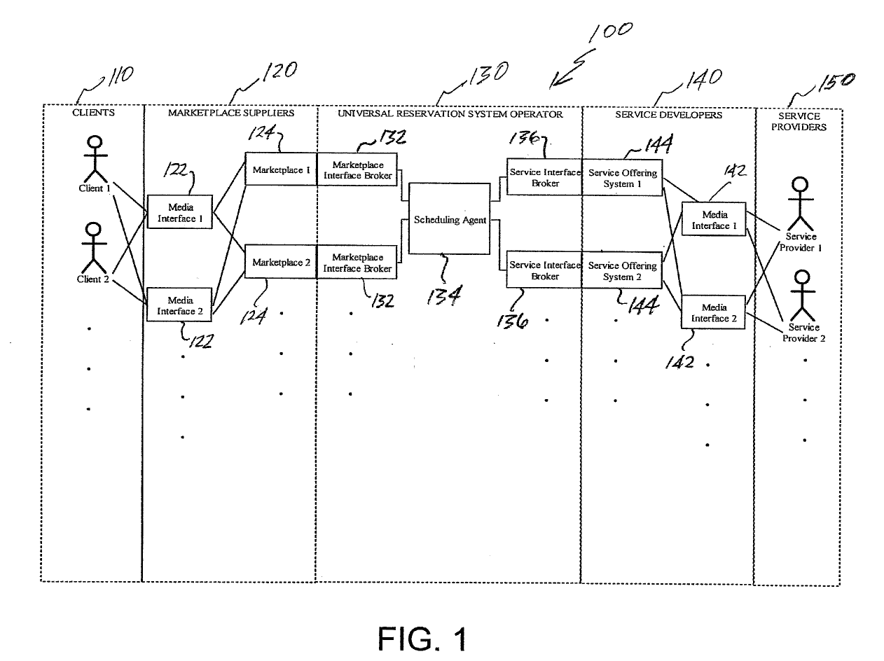

FIG. 1 shows one embodiment of a computer network based universal reservation system (CNBURS) 100. The CNBURS 100 conforms to the business to media (B2M) reservation standard. In general, the B2M reservation standard specifies a standard that provides for the visualization of, and the renting/scheduling of services, simultaneously, in real time, and over multiple analog and digital media in multiple analog and digital marketplaces. The B2M reservation standard is more specifically described in a separate United States Patent Application filed contemporaneously herewith entitled “BUSINESS TO MEDIA RESERVATION STANDARD” (which application claims priority from U.S. Provisional Application No. 60/981,752 filed Oct. 22, 2007), the entire disclosure of which is incorporated by reference herein.

The CNBURS 100 represents one possible implementation of the B2M reservation standard and it is done in digital and computer network enabled technology. As illustrated in FIG. 1, CNBURS 100 includes five (5) groups of actors and six (6) types of components. The five groups of actors are: clients 110, marketplace suppliers 120, the universal reservation system operator 130, service developers 140 and service providers 150. The six types of components are: media interface 122 and 142, marketplace 124, the marketplace interface broker 132, the scheduling agent 134, the service interface broker 136 and the service offering system 144. The characteristics and roles of the various components of and actors involved in the CNBURS 100 are described below.

### CNBURS 100 Components

The media interfaces 122, 142 are a set of tools enabling communication through one-way media (e.g. billboards, newspapers, radio, analog TV, etc.) and two-way media (e.g. Internet, mobile phones, digital TV, etc.). One-way communication media are used by clients 110 to get information from marketplaces 124, and two-way communication media are used between service providers 150 and service offering systems 144 as well as between clients 110 and marketplaces 124. In this regard, the media interfaces 142 operated by the service developers 140 should provide for two-way communication, whereas the media interfaces 122 operated by the marketplace suppliers 120 may provide for one-way or two-way communication. Sets of tools are different for digital media and analog media. Tools for digital media include, for example, web applications, digital television (DTV) applications, mobile web applications, local applications (e.g., graphical user interfaces), and the like. Tools for analog media include, for example, graphics, texts, sounds, and the like.

The marketplace component 124 is a computer network enabled computer system where services are available through media interfaces 122 to the clients 110. In this regard, marketplaces 124 may also be referred to herein as marketplace systems 124. The marketplace 124 offers services available at the scheduling agent component 134 to the clients 110 and mediates within the reservation process of those services between the scheduling agent 134 and the clients 110. The marketplace 124 is a separate computer system from the scheduling agent 134 and uses the marketplace interface broker component 132 to communicate with the scheduling agent 134.

The marketplace interface broker (MIB) 132 is a tool enabling integration of marketplaces 124 with the scheduling agent 134. The MIB 132 provides functionality dependent upon different kinds of marketplaces 124 (e.g. different technologies, different business domains, different business functionality, etc.) and the ability to be connected to the scheduling agent 134. The MIB 132 communicates with scheduling agent 134 through a computer network (not shown).

The scheduling agent 134 is a computer network enabled computer system capable of processing all kinds of reservations (e.g. renting, reserving, scheduling, etc.) of all kinds of services on behalf of a service provider 150 and the handling of those reservations between marketplace interface brokers 132 and service interface brokers 136. In this regard, the scheduling agent 134 may also be referred to herein as the scheduling agent system 134. The scheduling agent 134 passes the services offer from the service offering systems 144 (placed there by service providers 150) to the marketplaces 124 and informs service providers 150 through the service offering systems 144 about reservation requests from the marketplaces 124. The scheduling agent 134 is connected via a computer network (not shown) to one or more service offering systems 144 (the number of service offering systems 144 is unlimited) using service interface brokers 136 and to one or more marketplaces 124 (the number of marketplaces 124 is unlimited) using marketplace interface brokers 132. There is only one scheduling agent 134 in the CNBURS 100 which is capable of serving every type of business domain.

The service interface broker (SIB) 136 is a tool enabling integration of service offering systems 144 with the scheduling agent 134. The SIB 136 provides functionality dependent upon different kinds of service offering systems 144 (e.g. different technologies, different business domains, different logical approaches, etc.) and the ability to be connected to the scheduling agent 134. The SIB 136 communicates with the scheduling agent 134 through a computer network (not shown).

The service offering system 144 is a computer network enabled computer system where services are defined and managed by service providers 150. In the CNBURS 100 of FIG. 1, service providers 150 define and manage services with a service offering system 144 through media interfaces 142 (e.g. using web applications, DTV applications, mobile web applications, local applications). The service offering system 144 makes services offered by service providers 150 available to the scheduling agent 134 and mediates in the reservation process of those services between the scheduling agent 134 and the service provider 150. The service offering system 144 is a separate computer system from the scheduling agent 134 and uses the service interface broker 136 to communicate with the scheduling agent 134.

### CNBURS Actors

The role of clients 110 is to rent/reserve/schedule/etc. services available on multiple marketplaces 124 through multiple media 122. Although two clients 110 are depicted in FIG. 1, there are no limits on the number of clients 110 using CNBURS 100.

The role of marketplace suppliers 120 is to provide marketplaces 124 in any area of perceived market need (e.g. computer shops, car shops, hair-dressers, ski rentals, hotels, etc.). Marketplace suppliers 120 use marketplace interface brokers 132 to integrate marketplaces 124 with the scheduling agent 134. More details regarding integration of marketplaces 124 with the scheduling agent 134 is provided in a separate United States Patent Application filed contemporaneously herewith entitled “BUSINESS TO MEDIA RESERVATION BUSINESS PROCESS” (which application claims priority from U.S. Provisional Application No. 60/981,744 filed Oct. 22, 2007), the entire disclosure of which is incorporated by reference herein. The marketplaces 124 can be unique (e.g. auto repair appointment reservations, hotel reservations or car purchase reservations, etc.), linked (e.g. hotel, restaurant and rental car reservations) or universal (every registered service provider, limited only by the parameters of the client search). Marketplace suppliers 120 also provide media interfaces 122 for communication between marketplaces 124 and clients 110. The media used for communication can be analog (e.g. newspapers, billboards, etc.) and/or digital (e.g. Internet, mobile phones, digital TV, etc.). It is a choice of marketplace suppliers 120 what communication possibilities and which media are available for clients. An unlimited number of marketplaces 124 can be created and an unlimited number of marketplace suppliers 120 can be involved in the CNBURS 100.

The role of the scheduling agent supplier 130 is to provide the scheduling agent 134, which is responsible for exchanging information between service offering systems 144 and marketplaces 124 in both directions and is responsible for completing reservations on behalf of a service provider 150, if the service provider 150 decides to delegate reservation handling to the scheduling agent 134.

Service developers 140 utilize the service interface broker 136 to develop and configure the service offering system 144 for a specific category of services (e.g. ski rental equipment reservations or ski equipment purchase reservation), to define delegations to the scheduling agent 134, and to name specific existing marketplaces 124 where the offer will be available to the clients 110. More details regarding integration of service offering systems 144 with the scheduling agent 134 is provided in a separate United States Patent Application filed contemporaneously herewith entitled “BUSINESS TO MEDIA RESERVATION BUSINESS PROCESS” (which application claims priority from U.S. Provisional Application No. 60/981,744 filed Oct. 22, 2007), the entire disclosure of which is incorporated by reference herein. The delegations to the scheduling agent 134 may be sufficient to allow the scheduling agent 134 to complete the reservation. The scheduling agent 134 may provide a universal service code (USC) associated with each service, which facilitates the use of one-way media for presenting those services to the clients 110 on the marketplaces 124. However, a USC may not be required to use one-way media. In general, a USC is a unique sequence of letters, numerals, symbols or combination of letters, numerals and/or symbols that is associated with a particular service. USCs (in the context of reserving services) are more specifically described in a separate United States Patent Application filed contemporaneously herewith entitled “UNIVERSAL SERVICE CODE FOR RESERVATIONS” (which application claims priority from U.S. Provisional Application No. 60/981,725 filed Oct. 22, 2007), the entire disclosure of which is incorporated by reference herein. There can be an unlimited number of service offering systems 144 and an unlimited number of service developers 140 can be involved in the CNBURS 100.

The role of service providers 150 is to have an offer of services, to give an access to those services to the scheduling agent 134 and to handle reservations incoming from the scheduling agent 134 or (optionally) fully delegate reservations to the scheduling agent 134. Although two service providers 150 are depicted in FIG. 1, there are no limits on the number of service providers 150 using CNBURS 100.

### CNBURS Interactions

The CNBURS 100 undertakes a number of actions/processes including, for example, offer construction, marketplace construction, and reservation processing.

Offer Construction

The service developer 140 develops a service offering system 144 and, by using the service interface broker 136, integrates this service offering system 144 with the scheduling agent 134. The service provider 150 uses the service offering system 144 to define services, which will be available for reservations and describes those services in the service offering system 144 by defining their features such as, for example: price, needed resources, place, availability, etc. The service provider 150 may also include information indicating whether the scheduling agent 134 is delegated authority to complete reservations relating to an offer of the services. Using available features in the service offering system 144, the service provider 150 creates delegations by deciding which service reservations will be handled by the service provider 150 and which will be handled by the scheduling agent 134. When the service provider 150 decides that the offer is ready, the service provider 150 commands the service offering system 144 to place the offer with the scheduling agent 134. The service offering system 144 does not have to be connected permanently to the scheduling agent 134, but when not connected the services without delegations will not be available to the clients 110. Services without delegations are available only when the service offering system 144 is connected to the scheduling agent 134.

Marketplace Construction

The marketplace supplier 120, using the marketplace interface broker 132 integrates a given marketplace 124 with the scheduling agent 134. The marketplace supplier 120 chooses at least one business domain from the domains available in the scheduling agent 134 and develops at least one media interface 122 through which clients 110 will have an access to the services from this domain. The marketplace 124 stays permanently connected through a computer network (not shown) with the scheduling agent 134 and presents to the clients 110 up to date offers with available services only.

Reservation Processing

The client 110 gets the information about the offer and its availability on a marketplace 124 through a chosen media interface 122, which enables marketplace to client-directed communication. If this media interface 122 also supports a return communication channel (e.g., it is two-way), the client 110 uses it for completing the reservation for a chosen service. When the chosen media interface 122 does not have a return channel, the client 110 uses another available media interface 122 with return communication capabilities to complete this reservation. As the marketplace 124 stays connected to the scheduling agent 134, the reservation request is transmitted, over a computer network (not shown), immediately from the marketplace 124 to the scheduling agent 134. If the scheduling agent 134 was given delegation for the chosen services, it accepts or refuses the reservation. If not, the scheduling agent 134 (over a computer network) informs the service offering system 144 and the service provider 150 about the reservation request. The service provider 150 decides whether to accept it or refuse it. When the reservation status is set, the scheduling agent 134 (over a computer network) informs the marketplace 124 about this status and the marketplace 124 makes this information available to the client 110 through a given media interface 122.

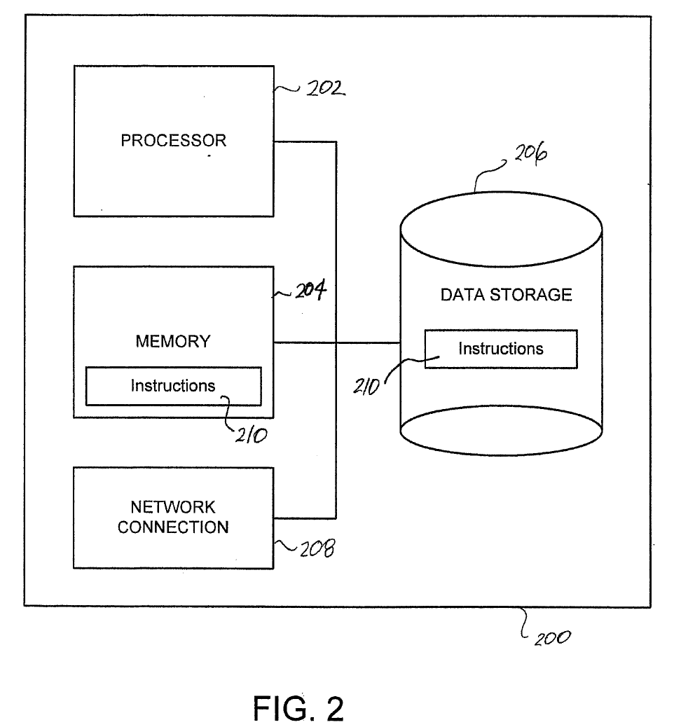

Referring now to FIG. 2, one embodiment of an exemplary computing system 200 that may be utilized to implement one or more of the various components of the CNBURS 100. For example, scheduling agent 134, the service offering systems 144, and the marketplaces 124 may be implemented using separate computing systems 200 such as depicted in FIG. 2. Computing system 200 depicted in FIG. 2 is not the only computing system architecture that be utilized to implement various components of CNBURS 100 and differently configured computing systems or the like may be utilized. Further, multiple computing systems 200 such as depicted in FIG. 2 may be utilized to implement a single component within the CNBURS 100.

Computing system 200 includes, among other components, a processor 202, memory 204, a data storage device 206 (e.g., a hard drive), and a network connection device 208 (e.g., an Ethernet card, a WiFi network card, a modem or the like). Computing system 200 may include additional components that are not illustrated in FIG. 2 including, for example, a power supply, an input device (e.g., a keyboard, a pointing device), and an output device (e.g., a display). The processor 202 executes computer program instructions 210 stored in memory 204 and/or on the data storage device 206 that enable the computing system 200 to provide the desired functionality of the component within the CNBURS 100 that computing system 200 is be used to implement.

The computer program instructions 210 may, for example in the case of computing system 200 being used to implement a marketplace 124, include instructions to provide the various functionalities of the marketplace 124 including offering services available at the scheduling agent 134 to the clients 110 via the media interfaces 122 and mediating in the reservation process of such services between the scheduling agent 134 and the clients 110. In this regard, the computer program instructions 210 executable by the processor 202 of the computing system 200 may also implement some portion or the entirety of the marketplace interface broker 132 corresponding with the marketplace 124.

The computer program instructions 210 may, for example in the case of computing system 200 being used to implement the scheduling agent 134, include instructions enabling the computing system 200 to provide the various functionalities of the scheduling agent 134 including passing services offers from the service offering systems 144 to the marketplaces 124, informing service providers 150 through the service offering systems 144 about reservation requests from the marketplaces 124, and scheduling (when delegated authority) on behalf of the service providers 150 all kinds of reservations by clients 110 of all kinds of services. In this regard, the computer program instructions 210 executable by the processor 202 of the computing system 200 may also implement some portion or the entirety of the marketplace interface brokers 132 and the service interface brokers 136.

The computer program instructions 210 may, for example in the case of computing system 200 being used to implement a service offering system 144, include instructions to provide the various functionalities of the service offering system 144 including enabling service providers 150 to define and manage services through media interfaces 142, making the services offered by service providers 150 available to the scheduling agent 134, and mediating in the reservation process between the scheduling agent 134 and the service providers 150. In this regard, the computer program instructions 210 executable by the processor 202 of the computing system 200 may also implement some portion or the entirety of the service interface broker 136 corresponding with the service offering system 144.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. An architecture of a computer network based universal reservation system enabling reservations between one or more service providers and one or more customers, wherein the reservations relate to offers of services by the service providers, said system comprising:
a scheduling agent system, said scheduling agent system being enabled to receive one or more offers of services available for reservation, wherein the offers of services are defined by the service providers;
one or more service offering systems, each said service offering system enabling service providers to define one or more offers of services available for reservation with customers, wherein an offer of services includes information indicating whether said scheduling agent system is delegated authority to complete reservations with customers relating to the offer of services; and
one or more marketplace systems, each said marketplace system being enabled to receive the one or more offers of services from said scheduling agent system, present the customers the one or more offers of services, receive reservation requests from the customers relating to the one or more offers of services, and communicate received reservation requests to said scheduling agent system;
wherein said scheduling agent system communicates the one or more offers of services from said one or more service offering systems to said one or more marketplace systems; and
wherein said scheduling agent system processes reservation requests received from said one or more marketplace systems.

2. The system of claim 1 wherein a service offered by the one or more service providers comprises an arrangement wherein a customer receives the use of a resource from a service provider.

3. The system of claim 2 wherein the customer receives use of the resource for a scheduled period of time.

4. The system of claim 2 wherein the service provider maintains ownership of the resource during the service.

5. The system of claim 2 wherein the resource comprises a good.

6. The system of claim 2 wherein the resource comprises an activity that is performed.

7. The system of claim 6 wherein at least a portion of the activity is performed by one or more individuals.

8. The system of claim 6 wherein at least a portion of the activity is performed by a device.

9. The system of claim 1 further comprising:
one or more service interface brokers, each said service interface broker corresponding with one of said service offering systems and being enabled to connect said corresponding service offering system with said scheduling agent system for communication there between via a computer network.

10. The system of claim 1 further comprising:
one or more marketplace interface brokers, each said marketplace interface broker corresponding with one of said one or more marketplace systems and being enabled to connect said corresponding marketplace system with said scheduling agent system for communication there between via a computer network.

11. The system of claim 1 further comprising:
at least one media interface providing at least one-way communication from said one or more marketplace systems to the customers, wherein the offers of services available for reservation are communicated from said one or more marketplace systems to the customers via said at least one media interface.

12. The system of claim 11 wherein said at least one media interface provides two-way communication between said one or more marketplace systems and the customers, wherein the reservation requests are communicated from the customers to said one or more marketplace systems via the same said at least one media interface.

13. The system of claim 11 further comprising:
at least one additional media interface providing at least return channel communication from the customers to said one or more marketplace systems, wherein the reservation requests are communicated from the customers to said one or more marketplace systems via said at least one additional media interface.

14. The system of claim 1 further comprising:
at least one media interface enabling two-way communication between said one or more service offering systems and the service providers, wherein the at least one media interface enables operation of said one or more service offering systems by the service providers to define offers of services available for reservation.

15. The system of claim 1 wherein the service providers directly control operation of said one or more service offering systems to define offers of services available for reservation.

16. The system of claim 1 wherein said scheduling agent system completes reservation requests received from said one or more marketplace systems for offers of services including information indicating that said scheduling agent system is delegated authority to complete reservations.

17. The system of claim 1 wherein at least one offer of services includes information indicating that said scheduling agent system is not delegated authority to complete reservations relating thereto, and wherein said scheduling agent system informs the service providers about the reservation requests for which said scheduling agent system is not delegated authority to complete through said one or more service offering systems.

18. The system of claim 1 wherein said scheduling agent system, said one or more service offering systems, and said one or more marketplace systems each comprise a separate computer processor and software code separately executable by said separate computer processors.

19. The system of claim 18 wherein said separate computer processors comprising said scheduling agent system and said one or more service offering systems are connectable via a computer network, and wherein said separate computer processors comprising said scheduling agent system and said one or more marketplace systems are connectable via a computer network.

20. The system of claim 1 wherein said system includes only a single scheduling agent system communicating offers of services from a plurality of service offering systems to a plurality of marketplace systems and processing reservation requests received from said plurality of marketplace systems.

21. An architecture of a computer network based universal reservation system enabling reservations between one or more service providers and one or more customers, wherein the reservations relate to offers of services by the service providers, said system comprising:
a scheduling agent system implemented in the form of computer readable program code executable by a computer processor, said scheduling agent system being enabled to receive one or more offers of services available for reservation, wherein the offers of services are defined by the service providers;
a plurality of service offering systems implemented in the form of computer readable program code executable by separate computer processors, each said service offering system enabling service providers to define one or more offers of services available for reservation with customers, wherein an offer of services includes information indicating whether said scheduling agent system is delegated authority to complete reservations with customers relating to the offer of services;
a plurality of service interface brokers, each said service interface broker corresponding with one of said service offering systems and providing an interface between said corresponding service offering system and said scheduling agent system for communication via a computer network between the computer processor executing scheduling agent system program code and the computer processor executing service offering system program code;
a plurality of marketplace systems implemented in the form of computer readable program code executable by separate computer processors, each said marketplace system being enabled to receive the one or more offers of services from said scheduling agent system, present the customers the one or more offers of services, receive reservation requests from the customers relating to the one or more offers of services, and communicate received reservation requests to said scheduling agent system;
a plurality of marketplace interface brokers, each said marketplace interface broker corresponding with one of said one or more marketplace systems and providing an interface between said corresponding marketplace system and said scheduling agent system for communication via a computer network between the computer processor executing scheduling agent system program code and the computer processor executing marketplace system program code;
wherein said scheduling agent system communicates the one or more offers of services from said plurality of service offering systems to said plurality of marketplace systems using the service and marketplace interface brokers; and
wherein said scheduling agent system processes reservation requests received from said plurality of marketplace systems.

22. The system of claim 21 wherein a service offered by the one or more service providers comprises an arrangement wherein a customer receives the use of a resource from a service provider.

23. The system of claim 22 wherein the customer receives use of the resource for a scheduled period of time.

24. The system of claim 22 wherein the service provider maintains ownership of the resource during the service.

25. The system of claim 22 wherein the resource comprises a good.

26. The system of claim 22 wherein the resource comprises an activity that is performed.

27. The system of claim 26 wherein at least a portion of the activity is performed by one or more individuals.

28. The system of claim 26 wherein at least a portion of the activity is performed by a device.

29. The system of claim 21 wherein the service providers directly control operation of said plurality of service offering systems to define offers of services available for reservation.

30. The system of claim 21 wherein said scheduling agent system completes reservation requests received from said plurality of marketplace systems for offers of services including information indicating that said scheduling agent system is delegated authority to complete reservations.

31. The system of claim 21 wherein at least one offer of services includes information indicating that said scheduling agent system is not delegated authority to complete reservations relating thereto, and wherein said scheduling agent system informs the service providers about the reservation requests for which said scheduling agent system is not delegated authority to complete through said plurality of service offering systems.
